(19) United States
(12) Patent Application Publication
(10) Pub. No.: US 2025/0071643 A1
(43) Pub. Date: Feb. 27, 2025

(54) HANDOVER METHOD, TERMINAL, AND NETWORK SIDE DEVICE

(71) Applicant: VIVO MOBILE COMMUNICATION CO., LTD., Dongguan (CN)

(72) Inventors: Erhao SONG, Dongguan (CN); Wei BAO, Dongguan (CN)

(73) Assignee: VIVO MOBILE COMMUNICATION CO., LTD., Dongguan (CN)

(21) Appl. No.: 18/942,314

(22) Filed: Nov. 8, 2024

Related U.S. Application Data
(63) Continuation of application No. PCT/CN2023/092420, filed on May 6, 2023.

(30) Foreign Application Priority Data
May 9, 2022 (CN) 202210499849.2
Jul. 29, 2022 (CN) 202210910523.4

(51) Int. Cl. H04W 36/08; H04W 36/00

(52) U.S. Cl. CPC H04W 36/087; H04W 36/0072

(57) ABSTRACT

A handover method, a terminal, and a network side device are provided. The handover method includes: initiating, by a source-distributed unit (S-DU), layer 1 (L1)/layer 2 (L2) handover; sending, by the S-DU, a first interface message to a centralized unit (CU); and after receiving the first interface message, the CU sending the first interface message to a target-distributed unit (T-DU), where the first interface message includes at least one of the following: indication information used to indicate that L1/L2 handover has been initiated; identity information of a target cell; a transmission configuration indicator (TCI) state associated with a target cell; a maximum quantity of times that the T-DU schedules a terminal; or a length of a first timer, where the T-DU schedules the terminal during running of the first timer.

### CROSS-REFERENCE TO RELATED APPLICATIONS

This application is a continuation of International Application No. PCT/CN2023/092420, filed May 6, 2023, which claims priority to Chinese Patent Application No. 202210499849.2, filed May 9, 2022, and to Chinese Patent Application No. 202210910523.4, filed Jul. 29, 2022. The entire contents of each of the above-referenced applications are expressly incorporated herein by reference.

### TECHNICAL FIELD

This application relates to the field of communication technologies, and specifically relates to a handover method, a terminal, and a network side device.

### BACKGROUND

Access network devices (for example, an NR node (NR NodeB, gNB)) may include Centralized Units (CUs) and Distributed Units (DUs), and the CUs and the DUs are connected through F1 interfaces. Usually, one access network device includes only one CU, and includes one or more DUs. One DU corresponds to one or more cells.

L1/L2 handover is a scheme in which a DU performs handover judgment based on an L1 measurement result, possibly by using rach-less access. However, a specific solution related to L1/L2 handover is not provided in a related technology, which may cause failure of L1/L2 handover of a terminal, thereby affecting communication performance.

### SUMMARY

Embodiments of this application provide a handover method, a terminal, and a network side device.

According to a first aspect, a handover method is provided, including: An S-DU initiates L1/L2 handover; the S-DU performs at least one of the following: sends a first interface message to a T-DU, or receives a second interface message, where the first interface message is used to indicate the T-DU to schedule a terminal; and the second interface message includes a TA value of a candidate cell, and the TA value of the candidate cell is used for uplink synchronization during handover of the terminal.

According to a second aspect, a handover method is provided, including: A T-DU performs at least one of the following: receives a first interface message, or sends a second interface message to an S-DU, where the first interface message is used to indicate the T-DU to schedule a terminal; and the second interface message includes a TA value of a candidate cell, the TA value of the candidate cell is used by the S-DU for performing sending to a terminal, and the TA value of the candidate cell is used for uplink synchronization during handover of the terminal.

According to a third aspect, a handover method is provided, including: A CU performs at least one of the following: sends a first interface message to a T-DU, or sends a second interface message to an S-DU, where the first interface message is used to indicate the T-DU to schedule a terminal; and the second interface message includes a TA value of a candidate cell, and the TA value of the candidate cell is used for uplink synchronization during handover of the terminal.

According to a fourth aspect, a handover method is provided, including: A terminal monitors a PDCCH of a T-DU, to obtain a scheduling request sent by the T-DU. The terminal sends uplink data to the T-DU in a case that the terminal successfully receives, based on the scheduling request, a PDCCH including a C-RNTI allocated by a target cell.

According to a fifth aspect, a first network side device is provided, including a communication module, configured to initiate L1/L2 handover. The communication module is further configured to perform at least one of the following: send a first interface message to a T-DU, or receive a second interface message, where the first interface message is used to indicate the T-DU to schedule a terminal; and the second interface message includes a TA value of a candidate cell, and the TA value of the candidate cell is used for uplink synchronization during handover of the terminal.

According to a sixth aspect, a second network side device is provided, including a communication module, configured to perform at least one of the following: receive a first interface message, or send a second interface message to an S-DU, where the first interface message is used to indicate the second network side device to schedule a terminal; and the second interface message includes a TA value of a candidate cell, the TA value of the candidate cell is used by the S-DU for performing sending to a terminal, and the TA value of the candidate cell is used for uplink synchronization during handover of a terminal.

According to a seventh aspect, a third network side device is provided, including a communication module, configured to perform at least one of the following: send a first interface message to a T-DU, or send a second interface message to an S-DU, where the first interface message is used to indicate the T-DU to schedule a terminal; and the second interface message includes a TA value of a candidate cell, and the TA value of the candidate cell is used for uplink synchronization during handover of the terminal.

According to an eighth aspect, a terminal is provided, including a communication module, configured to monitor a PDCCH of a T-DU, to obtain a scheduling request sent by the T-DU. The communication module is further configured to send uplink data to the T-DU in a case that a PDCCH including a C-RNTI allocated by a target cell is successfully received based on the scheduling request.

According to a ninth aspect, a terminal is provided. The terminal includes a processor and a memory, the memory stores a program or an instruction that can be run on the processor, and the program or the instruction is executed by the processor to implement the steps of the method according to the fourth aspect.

According to a tenth aspect, a terminal is provided, including a processor and a communication interface, where the communication interface is configured to: monitor a PDCCH of a T-DU, to obtain a scheduling request sent by the T-DU; and send uplink data to the T-DU in a case that a PDCCH including a C-RNTI allocated by a target cell is successfully received based on the scheduling request.

According to an eleventh aspect, a network side device is provided. The network side device includes a processor and a memory, the memory stores a program or an instruction that can be run on the processor, and the program or the instruction is executed by the processor to implement the steps of the methods according to any one of the first aspect to the third aspect.

According to a twelfth aspect, a network side device is provided, including a processor and a communication interface, where the processor or the communication interface is used to implement the steps of the methods according to any one of the first aspect to the third aspect.

According to a thirteenth aspect, a handover system is provided, including a terminal and a network side device. The terminal may be configured to implement the steps of the method according to the fourth aspect, and the network side device may be configured to implement the steps of the methods according to any one of the first aspect to the third aspect.

According to a fourteenth aspect, a readable storage medium is provided. The readable storage medium stores a program or an instruction, and the program or the instruction is executed by a processor to implement the steps of the methods according to any one of the first aspect to the fourth aspect.

According to a fifteenth aspect, a chip is provided. The chip includes a processor and a communication interface, the communication interface is coupled to the processor, and the processor is configured to run a program or an instruction to implement the steps of the methods according to any one of the first aspect to the fourth aspect.

According to a sixteenth aspect, a computer program/program product is provided. The computer program/program product is stored in a storage medium, and the computer program/program product is executed by at least one processor to implement the steps of the methods according to any one of the first aspect to the fourth aspect.

In the embodiments of this application, an S-DU initiates L1/L2 handover and performs at least one of the following: sends a first interface message to a T-DU, or receives a second interface message. The first interface message is used to indicate the T-DU to schedule a terminal, to acknowledge completion or failure of handover, thereby avoiding failure of L1/L2 handover of the terminal and improving communication system performance. The second interface message includes a TA value of a candidate cell, and the TA value of the candidate cell is used for uplink synchronization during handover of a terminal, thereby reducing a delay of the uplink synchronization during handover of the terminal, avoiding failure of the L1/L2 handover of the terminal, and improving communication system performance.

### BRIEF DESCRIPTION OF DRAWINGS

FIG. 1 is a schematic diagram of a wireless communication system according to an embodiment of this application;

FIG. 2 is a flowchart of a handover method according to an embodiment of this application;

FIG. 3 is a flowchart of a handover method according to an embodiment of this application;

FIG. 4 is a flowchart of a handover method according to an embodiment of this application;

FIG. 5 is a flowchart of a handover method according to an embodiment of this application;

FIG. 6 is a schematic diagram of a structure of a terminal according to an embodiment of this application; and

FIG. 7 is a schematic diagram of a structure of a first network side device according to an embodiment of this application;

FIG. 8 is a schematic diagram of a structure of a second network side device according to an embodiment of this application;

FIG. 9 is a schematic diagram of a structure of a third network side device according to an embodiment of this application;

FIG. 10 is a schematic diagram of a structure of a communication device according to an embodiment of this application;

FIG. 11 is a schematic diagram of a structure of a terminal according to an embodiment of this application; and

FIG. 12 is a schematic diagram of a structure of a network side device according to an embodiment of this application.

### DETAILED DESCRIPTION

The following clearly describes the technical solutions in the embodiments of this application with reference to the accompanying drawings in the embodiments of this application. Apparently, the embodiments described are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} generation (6G) communication system.

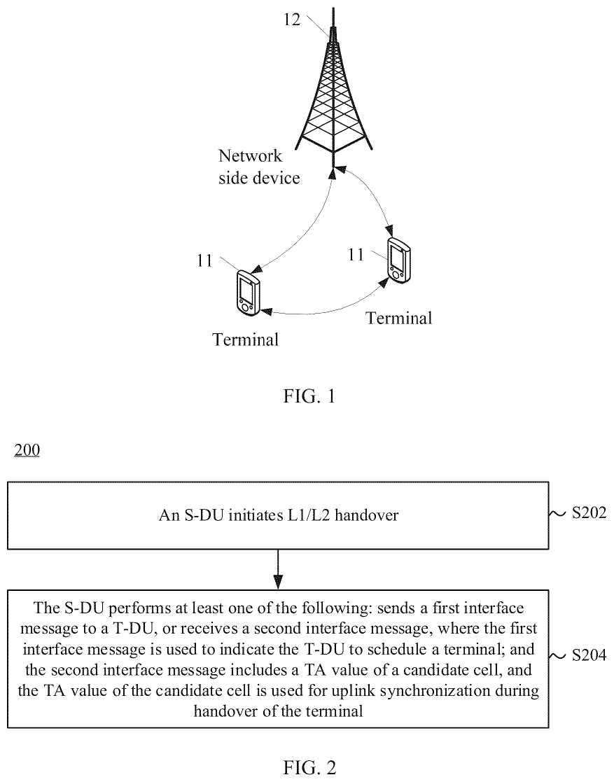

FIG. 1 is a block diagram of a wireless communication system to which the embodiments of this application may be applied. The wireless communication system includes a terminal 11 and a network side device 12. The terminal 11 may be a terminal side device such as a mobile phone, a tablet personal computer, a laptop computer or a notebook computer, a personal digital assistant (PDA), a palmtop computer, a netbook, an ultra-mobile personal computer (UMPC), a mobile internet device (MID), an augmented reality (AR)/virtual reality (VR) device, a robot, a wearable device, vehicle user equipment (VUE), pedestrian user equipment (PUE), a smart home (a home device with a wireless communication function, such as a refrigerator, a television, a washing machine, or a furniture), a game console, a personal computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. It should be noted that a specific type of the terminal 11 is not limited in the embodiments of this application. The network side device 12 may include an access network device or a core network device. The access network device may also be referred to as a radio access network device, a radio access network (RAN), a radio access network function, or a radio access network unit. The access network device may include a base station, a wireless local area network (WLAN) access point, a Wireless Fidelity (Wi-Fi) node, or the like. The base station may be referred to as a NodeB, an evolved NodeB (eNB), an access point, a base transceiver station (BTS), a radio base station, a radio transceiver, a basic service set (BSS), an extended service set (ESS), a home NodeB, a home evolved NodeB, a transmission reception point (TRP), or another appropriate term in the field. As long as a same technical effect is achieved, the base station is not limited to a specified technical term. It should be noted that, in this application, only a base station in an NR system is used as an example, and a specific type of the base station is not limited.

A handover method provided in the embodiments of this application is described in detail by using some embodiments and application scenarios thereof with reference to the accompanying drawings.

As shown in FIG. 2, an embodiment of this application provides a handover method 200. The method may be performed by a Source-Distributed Unit (S-DU). In other words, the method may be performed by software or hardware installed in the S-DU. The method includes the following steps.

S202: The S-DU initiates L1/L2 handover.

In this embodiment, the S-DU is a serving network side device before L1/L2 handover of a terminal, and a T-DU subsequently mentioned is a serving network side device after the L1/L2 handover of the terminal. The various embodiments of this application may be applied to a rach-less access scenario, or may be applied to a non-rach-less access scenario.

For example, the step in which the S-DU initiates the L1/L2 handover includes: The S-DU delivers an L1/L2 handover command to the terminal.

S204: The S-DU performs at least one of the following: sends a first interface message to a Target-Distributed Unit (T-DU), or receives a second interface message, where the first interface message is used to indicate the T-DU to schedule the terminal; and the second interface message includes a Timing Advance (TA) value of a candidate cell, and the TA value of the candidate cell is used for uplink synchronization during handover of the terminal.

It should be noted that this embodiment imposes no mandatory limitation on a sequence of occurrence of S202 and S204, that is, the sequence of S202 and S204 may be adjusted, or S202 and S204 may be initiated at the same time.

In some embodiments, the first interface message is used to notify the T-DU of a target cell for which handover is initiated and a to-be-handed-over target cell.

In some embodiments, the first interface message includes at least one of the following: (1) indication information used to indicate L1/L2 handover initiation; (2) identity information of a target cell, where the target cell is a serving cell after the L1/L2 handover of the terminal; (3) a Transmission Configuration Indicator (TCI) state associated with a target cell, where the target cell is a serving cell after the L1/L2 handover of the terminal; (4) a maximum quantity of times that the T-DU schedules the terminal; or (5) a length of a first timer, where the T-DU schedules the terminal during running of the first timer. It may be understood that, after initiating initial scheduling of the terminal, the T-DU may start the first timer. During running of the first timer, if the scheduling of the terminal fails, the T-DU may schedule the terminal again. If the first timer expires, the T-DU may no longer schedule the terminal.

For example, the S-DU sends a first interface message to a Centralized Unit (CU), where the first interface message may be, for example, a UE Context Modification Require message. After receiving the first interface message, the CU sends a first interface message to the T-DU, for example, a UE Context Modification Request message, where the first interface message is associated with a to-be-handed-over terminal.

For another example, the S-DU sends a first interface message to the CU and sends a downlink data delivery status indication to the CU, so as to notify the CU of a downlink data packet that is not successfully transmitted in the S-DU, so that the CU sends the downlink data packet to the T-DU for continuous transmission.

In this embodiment, after receiving the first interface message, the T-DU may schedule the terminal, for example, send uplink scheduling (UL Grant), trigger aperiodic Channel State Information (CSI) reporting, or the like. The purpose of scheduling the terminal by the T-DU may be to acknowledge completion or failure of handover. In a case that the T-DU successfully decodes data carried in a Physical Uplink Control Channel (PUCCH) or a Physical Uplink Shared Channel (PUSCH) that is sent by the terminal after scheduling the terminal, completion of handover is acknowledged. In a case that the T-DU fails to decode data carried in a PUCCH or a PUSCH that is sent by the terminal, the T-DU may schedule the terminal again until a quantity of scheduling times exceeds a maximum quantity of scheduling times, or scheduling time exceeds the length of the first timer. In some embodiments, in a case that the quantity of scheduling times of the terminal by the T-DU exceeds the maximum quantity of scheduling times, or the scheduling time exceeds the length of the first timer, scheduling of the terminal may be stopped, and the T-DU acknowledges failure of handover.

In this embodiment, the L1/L2 handover may be inter-DU L1/L2 handover. Handover execution may be rach-less access. The T-DU may obtain, by using the first interface message sent by the S-DU, a time of L1/L2 handover and a handed-over target cell, so as to schedule a terminal to acknowledge completion, thereby avoiding failure of the L1/L2 handover of the terminal, and improving communication system performance.

For another example, the T-DU sends, to the CU, an interface message, such as a UE Context Modification Require message, where the message carries the TA value of the candidate cell. The CU sends, to the S-DU, a second interface message, such as a UE Context Modification Request message, where the second interface message carries the TA value of the candidate cell. In this embodiment, the T-DU sends the TA value that is of the terminal and that is in the candidate cell to the S-DU, and the S-DU sends the TA value to the terminal for uplink synchronization in the target cell, thereby reducing a delay of uplink synchronization during handover of the terminal, avoiding failure of the L1/L2 handover of the terminal, and improving communication system performance.

In this embodiment, for the inter-DU L1/L2 handover, the S-DU may obtain TA information of the terminal in the target cell by using the second interface message, thereby reducing a delay of uplink synchronization during handover of the terminal, avoiding failure of the L1/L2 handover of the terminal, and improving communication system performance.

According to the handover method provided in this embodiment of this application, an S-DU initiates L1/L2 handover and performs at least one of the following: sends a first interface message to a T-DU, or receives a second interface message. The first interface message is used to indicate the T-DU to schedule a terminal, to acknowledge completion or failure of handover, thereby avoiding failure of L1/L2 handover of the terminal and improving communication system performance. The second interface message includes a TA value of a candidate cell, and the TA value of the candidate cell is used for uplink synchronization during handover of a terminal, thereby reducing a delay of the uplink synchronization during handover of the terminal, avoiding failure of the L1/L2 handover of the terminal, and improving communication system performance.

In an embodiment, in embodiment 200, after the S-DU sends the first interface message, the method further includes: The S-DU receives a third interface message, where the third interface message is sent from the T-DU after confirming the handover is completed or failed, and the third interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; (4) an index or an identity associated with an applied Radio Resource Control (RRC) reconfiguration message; or (5) indication information used to indicate completion or failure of L1/L2 handover.

In this embodiment, after confirming the handover is succussed or failed, the T-DU may send an interface message to the CU, for example, a UE Context Modification Require message, indicating to the CU that the L1/L2 handover succeeds or fails. In this way, the CU may send a third interface message to the S-DU, for example, a UE Context Modification Request message. This embodiment helps the S-DU acknowledge completion or failure of handover of the terminal.

In an embodiment, the second interface message mentioned in embodiment 200 further includes at least one of the following: (1) identity information of a source cell, where the source cell is a serving cell before the L1/L2 handover of the terminal; (2) identity information of a candidate cell, where the candidate cell is a candidate cell for the L1/L2 handover of the terminal; or (3) identity information of the terminal.

In an embodiment, before the S-DU receives the second interface message, the method further includes: the S-DU sends, to the terminal, a Random Access Channel (RACH) resource (such as a preamble) or a Sounding Reference Signal (SRS) resource, where the RACH resource or the SRS resource is allocated by a candidate cell to the terminal, and the RACH resource or the SRS resource is used to obtain the TA value of the candidate cell.

In this embodiment, the S-DU sends the RACH resource or the SRS resource to the terminal, the T-DU obtains the TA value that is of the terminal and that is in the candidate cell based on the preamble or the SRS that is sent by the terminal, the T-DU sends the TA value of the candidate cell to the S-DU, and the S-DU further sends the TA value to the terminal. This embodiment facilitates the T-DU to obtain the TA value that is of the terminal and that is in the candidate cell.

In an embodiment, before the S-DU sends the RACH resource or the SRS resource to the terminal, the method further includes: The S-DU receives a fourth interface message, where the fourth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) a RACH resource or an SRS resource allocated by a candidate cell to the terminal. In this embodiment, the S-DU may obtain the RACH resource or the SRS resource that is allocated by the candidate cell to the terminal, and may further indicate the RACH resource or the SRS resource to the terminal, so that the T-DU obtains, based on the preamble or the SRS that is sent by the terminal, the TA value that is of the terminal and that is in the candidate cell.

In this embodiment, the T-DU sends an interface message to the CU, where the interface message includes the RACH resource, the SRS resource, or the like that is allocated by the candidate cell to the terminal. The CU sends the fourth interface message to the S-DU, where the fourth interface message includes the RACH resource, the SRS resource, or the like that is allocated by the candidate cell to the terminal.

In an embodiment, before the S-DU receives the fourth interface message, the method further includes: The S-DU sends a fifth interface message, where the fifth interface message is used to request the RACH resource or the SRS resource, and the fifth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) indication information used to request an RACH resource or an SRS resource.

In this embodiment, the S-DU sends a fifth interface message to the CU, where the fifth interface message includes indication information used to request an RACH resource or an SRS resource, and the like. The CU sends an interface message to the T-DU, where the interface message includes indication information used to request an RACH resource or an SRS resource. In this embodiment, the RACH resource or the SRS resource is requested for the terminal, so that the T-DU obtains the TA value that is of the terminal and that is in the candidate cell based on the preamble or the SRS that is sent by the terminal.

In an embodiment, the RACH resource includes at least one of the following: a frequency, a time-frequency domain position, a sending period, an offset, an uplink carrier used, a Reference Signal (RS) index of an associated candidate cell, identity information of an associated candidate cell, a Physical Random Access Channel (PRACH) mask index, or a preamble index. The SRS resource includes at least one of the following: a frequency, a time-frequency domain position, a sending period, an offset, an uplink carrier used by the terminal, an RS index of an associated candidate cell, or identity information of an associated candidate cell.

In an embodiment, after the S-DU receives the second interface message, the method further includes: The S-DU sends the TA value of the candidate cell to the terminal; or the S-DU carries a TA value of a target cell in an L1/L2 handover command, where the target cell is a serving cell after the L1/L2 handover of the terminal.

In this embodiment, the S-DU sends the TA value of the candidate cell to the terminal, or carries the TA value of the target cell in the L1/L2 handover command when L1/L2 handover is triggered, where the L1/L2 handover command may be Downlink Control Information (DCI) or a Media Access Control Control Element (MAC CE), and the TA value of the candidate cell may be an absolute TA value that is of the terminal and that is in the candidate cell, or may be a relative TA value relative to a TA value of a serving cell.

In this embodiment, the TA value of the candidate cell is used for uplink synchronization during handover of the terminal, thereby reducing a delay of uplink synchronization during handover of the terminal, avoiding failure of the L1/L2 handover of the terminal, and improving communication system performance.

In an embodiment, the method further includes: The S-DU sends a sixth interface message to the T-DU and/or a Centralized Unit (CU), where the sixth interface message includes at least one of the following: (1) identity information of a candidate cell; (2) an L1 measurement result of a candidate cell; (3) a Channel State Information (CSI) measurement result of a candidate cell; or (4) identity information of the terminal, where the candidate cell is a candidate cell for the L1/L2 handover of the terminal.

In this embodiment, for example, the S-DU sends the L1 measurement result of the candidate cell to the CU, and the CU modifies or releases the candidate cell based on the measurement result, or initiates L3 handover.

In this embodiment, for another example, the S-DU sends the L1 measurement result of the candidate cell or the CSI measurement result of the candidate cell to the T-DU, and the T-DU performs subsequent scheduling and L1/L2 handover judgment based on the L1 measurement result or the CSI measurement result.

In this embodiment, for inter-DU L1/L2 handover, the T-DU may obtain a CSI measurement result that is of the terminal and that is in the target cell based on the sixth interface message sent by the S-DU, so as to perform scheduling in a timely manner after completion of handover.

In an embodiment, a sending occasion of the sixth interface message is one of the following: (1) sent periodically; (2) sent when the S-DU initiates the L1/L2 handover or delivers an L1/L2 handover command; (3) sent when the S-DU receives a Hybrid Automatic Repeat Request (HARQ) feedback for an L1/L2 handover command; (4) sent when the S-DU receives an L1 measurement result reported by the terminal; or (5) sent when the S-DU receives an CSI measurement result reported by the terminal.

In an embodiment, the sending occasion of the sixth interface message sending occasion is: sent when the S-DU initiates the L1/L2 handover; or sent when the S-DU receives the HARQ feedback for the L1/L2 handover command, where the CSI measurement result of the candidate cell is a CSI measurement result of a target cell, and the target cell is a serving cell after the L1/L2 handover of the terminal.

In this embodiment, the CSI measurement result of the candidate cell may include only the CSI measurement result of the target cell, but not a CSI measurement result of another candidate cell.

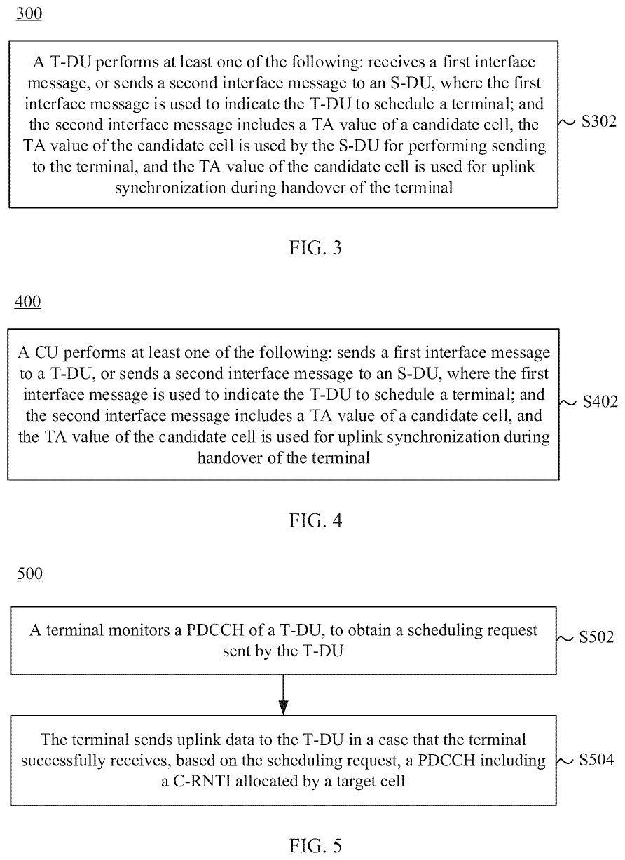

The handover method according to the embodiments of this application is described in detail above with reference to FIG. 2. A handover method according to another embodiment of this application is described in detail below with reference to FIG. 3. It may be understood that descriptions of the T-DU are the same as or correspond to the descriptions of the S-DU in the method shown in FIG. 2. To avoid repetition, related descriptions are appropriately omitted.

FIG. 3 is a schematic flowchart of an implementation of a handover method according to an embodiment of this application, where the method can be applied to a T-DU. As shown in FIG. 3, a method 300 includes the following steps.

S302: The T-DU performs at least one of the following: receives a first interface message, or sends a second interface message to an S-DU, where the first interface message is used to indicate the T-DU to schedule a terminal; and the second interface message includes a TA value of a candidate cell, the TA value of the candidate cell is used by the S-DU for performing sending to the terminal, and the TA value of the candidate cell is used for uplink synchronization during handover of the terminal.

The S-DU is a serving network side device before L1/L2 handover of the terminal, and the T-DU is a serving network side device after the L1/L2 handover of the terminal.

In this embodiment, for example, the S-DU sends an interface message to a CU, for example, a UE Context Modification Require message. After receiving the first interface message, the CU sends a first interface message to the T-DU, for example, a UE Context Modification Request message, where the first interface message is associated with a to-be-handed-over terminal.

It should be noted that both embodiment 300 and embodiment 200 use the first interface message. It may be understood that, in different embodiments, the type of the first interface message may be different. For example, the first interface message in embodiment 200 may be a UE Context Modification Require message, and the first interface message in embodiment 300 may be a UE Context Modification Request message. Similarly, in different embodiments, types of the second interface message, the third interface message, and the like may be different.

In this embodiment, for another example, the T-DU sends a second interface message to the CU, for example, a UE Context Modification Require message, where the message carries the TA value of the candidate cell. The CU sends an interface message to the S-DU, for example, a UE Context Modification Request message, where the message carries the TA value of the candidate cell. In this embodiment, the T-DU sends the TA value that is of the terminal and that is in the candidate cell to the S-DU, and the S-DU sends the TA value to the terminal for uplink synchronization in the target cell, thereby reducing a delay of uplink synchronization during handover of the terminal, avoiding failure of the L1/L2 handover of the terminal, and improving communication system performance.

In this embodiment, for implementation details in which the T-DU schedules the terminal to acknowledge completion or failure of handover, refer to the descriptions in embodiment 200.

According to the handover method provided in this embodiment of this application, a T-DU performs at least one of the following: receives a first interface message, or sends a second interface message to an S-DU. The first interface message is used to indicate the T-DU to schedule a terminal, thereby avoiding failure of the L1/L2 handover of the terminal and improving communication system performance. The second interface message includes a TA value of a candidate cell, and the TA value of the candidate cell is used for uplink synchronization during handover of the terminal, thereby reducing a delay of the uplink synchronization during handover of the terminal, avoiding failure of the L1/L2 handover of the terminal, and improving communication system performance.

In an embodiment, the first interface message includes at least one of the following: (1) indication information used to indicate that L1/L2 handover has been initiated; (2) identity information of a target cell; (3) a TCI state associated with a target cell; (4) a maximum quantity of times that the T-DU schedules the terminal; or (5) a length of a first timer, where the T-DU schedules the terminal during running of the first timer; and the target cell is a serving cell after the L1/L2 handover of the terminal.

In an embodiment, that the T-DU schedules the terminal includes at least one of the following: (1) sending an uplink grant to the terminal; and (2) triggering the terminal to perform aperiodic CSI reporting.

In this embodiment, after S302, the T-DU may perform at least one of the following: (1) sending the uplink grant to the terminal; and (2) triggering the terminal to perform the aperiodic CSI reporting.

In an embodiment, the method further includes acknowledging completion of handover in a case that the T-DU successfully decodes data carried in an uplink channel sent by the terminal.

In an embodiment, the method further includes: The T-DU schedules the terminal again until a quantity of scheduling times exceeds a maximum quantity of times of scheduling the terminal, or scheduling time exceeds a length of a first timer in a case that the T-DU fails to decode data carried in an uplink channel sent by the terminal.

In an embodiment, the method further includes: The T-DU stops scheduling the terminal, and acknowledges failure of handover in a case that the quantity of scheduling times of the terminal by the T-DU reaches or exceeds the maximum quantity of times of scheduling the terminal, or the scheduling time exceeds the length of the first timer.

In an embodiment, after the T-DU receives the first interface message, the method further includes: The T-DU sends a third interface message, where the third interface message is sent from the T-DU after confirming the handover is completed or failed, and the third interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; (4) an index or an identity associated with an applied radio resource control RRC reconfiguration message; or (5) indication information used to indicate completion or failure of L1/L2 handover.

In this embodiment, after confirming the handover is succeeded or failed, the T-DU may send a third interface message to the CU, for example, a UE Context Modification Require message, indicating to the CU that the L1/L2 handover succeeds or fails. In this way, the CU may send a third interface message to the S-DU, for example, a UE Context Modification Request message.

In an embodiment, the second interface message further includes at least one of the following: (1) identity information of a source cell, where the source cell is a serving cell before the L1/L2 handover of the terminal; (2) identity information of a candidate cell, where the candidate cell is a candidate cell for the L1/L2 handover of the terminal; or (3) identity information of the terminal.

In an embodiment, before the T-DU sends the second interface message, the method further includes: The T-DU obtains the TA value of the candidate cell based on a preamble or an SRS that is sent by the terminal.

In an embodiment, before the T-DU obtains the TA value of the candidate cell based on the preamble or the SRS that is sent by the terminal, the method further includes: The T-DU sends a fourth interface message, where the fourth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) a RACH resource or an SRS resource allocated by a candidate cell to the terminal.

In this embodiment, the T-DU sends the fourth interface message to the CU, where the fourth interface message includes the RACH resource, the SRS resource, or the like that is allocated by the candidate cell to the terminal. The CU sends an interface message to the S-DU, where the interface message includes the RACH resource, the SRS resource, or the like that is allocated by the candidate cell to the terminal.

In an embodiment, before the T-DU sends the fourth interface message, the method further includes: The T-DU receives a fifth interface message, where the fifth interface message is used to request the RACH resource or the SRS resource, and the fifth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) indication information used to request an RACH resource or an SRS resource.

In this embodiment, the S-DU sends an interface message to the CU, where the interface message includes indication information used to request an RACH resource or an SRS resource, and the like. The CU sends the fifth interface message to the T-DU, where the fifth interface message includes indication information used to request an RACH resource or an SRS resource.

In an embodiment, the RACH resource includes at least one of the following: a frequency, a time-frequency domain position, a sending period, an offset, an uplink carrier used, an RS index of an associated candidate cell, identity information of an associated candidate cell, a PRACH mask index, or a preamble index. The SRS resource includes at least one of the following: a frequency, a time-frequency domain position, a sending period, an offset, an uplink carrier used by the terminal, an RS index of an associated candidate cell, or identity information of an associated candidate cell.

In an embodiment, the method further includes: The T-DU receives a sixth interface message, where the sixth interface message includes at least one of the following: (1) identity information of a candidate cell; (2) an L1 measurement result of a candidate cell; (3) a CSI measurement result of a candidate cell; or (4) identity information of the terminal, where the candidate cell is a candidate cell for the L1/L2 handover of the terminal.

In this embodiment, the S-DU sends the L1 measurement result of the candidate cell or the CSI measurement result of the candidate cell to the T-DU, and the T-DU performs subsequent scheduling and L1/L2 handover judgment based on the L1 measurement result or the CSI measurement result.

In this embodiment, for inter-DU L1/L2 handover, the T-DU may obtain a CSI measurement result that is of the terminal and that is in the target cell based on the sixth interface message, so as to perform scheduling in a timely manner after completion of handover.

FIG. 4 is a schematic flowchart of an implementation of a handover method according to an embodiment of this application, where the method can be applied to a CU. As shown in FIG. 4, a method 400 includes the following steps.

S402: The CU performs at least one of the following: sends a first interface message to a T-DU, sends a second interface message to an S-DU, receives a first interface message sent by an S-DU, or receives a third interface message sent by a T-DU, where the first interface message is used to indicate the T-DU to schedule a terminal; and the second interface message includes a TA value of a candidate cell, and the TA value of the candidate cell is used for uplink synchronization during handover of the terminal.

The S-DU is a serving network side device before L1/L2 handover of the terminal, and the T-DU is a serving network side device after the L1/L2 handover of the terminal.

According to the handover method provided in this embodiment of this application, the CU performs at least one of the following: sends a first interface message to a T-DU, or sends a second interface message to an S-DU. The first interface message is used to indicate the T-DU to schedule a terminal, thereby avoiding failure of the L1/L2 handover of the terminal and improving communication system performance. The second interface message includes a TA value of a candidate cell, and the TA value of the candidate cell is used for uplink synchronization during handover of the terminal, thereby reducing a delay of the uplink synchronization during handover of the terminal, avoiding failure of the L1/L2 handover of the terminal, and improving communication system performance.

In an embodiment, the first interface message includes at least one of the following: (1) indication information used to indicate that L1/L2 handover has been initiated; (2) identity information of a target cell; (3) a transmission configuration indicator TCI state associated with a target cell; (4) a maximum quantity of times that the T-DU schedules the terminal; or (5) a length of a first timer, where the T-DU schedules the terminal during running of the first timer; and the target cell is a serving cell after the L1/L2 handover of the terminal.

In an embodiment, after the CU sends the first interface message to the T-DU, the method further includes: The CU sends a third interface message to the S-DU, where the third interface message is sent from the T-DU after confirming the handover is completed or failed, and the third interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; (4) an index or an identity associated with an applied radio resource control RRC reconfiguration message; or (5) indication information used to indicate completion or failure of L1/L2 handover.

In an embodiment, the second interface message further includes at least one of the following: (1) identity information of a source cell, where the source cell is a serving cell before the L1/L2 handover of the terminal; (2) identity information of a candidate cell, where the candidate cell is a candidate cell for the L1/L2 handover of the terminal; or (3) identity information of the terminal.

In an embodiment, before the CU sends the second interface message to the S-DU, the method further includes: The CU sends a fourth interface message to the S-DU, where the fourth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) a RACH resource or an SRS resource allocated by a candidate cell to the terminal.

In an embodiment, the method further includes: The CU sends a fifth interface message to the T-DU, where the fifth interface message is used to request the RACH resource or the SRS resource, and the fifth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) indication information used to request an RACH resource or an SRS resource.

In an embodiment, the method further includes: The CU receives a sixth interface message from the S-DU, where the sixth interface message includes at least one of the following: (1) identity information of a candidate cell; (2) an L1 measurement result of a candidate cell; (3) a channel state information CSI measurement result of a candidate cell; or (4) identity information of the terminal, where the candidate cell is a candidate cell for the L1/L2 handover of the terminal.

In an embodiment, the method further includes: After receiving the first interface message or downlink data delivery status indication from the S-DU, the CU starts to send downlink user data to the T-DU, so as to perform data path switching earlier before completion of handover, thereby reducing a data plane delay.

In an embodiment, the method further includes: After receiving the third interface message from the T-DU, and acknowledging completion of L1/L2 handover, the CU starts to send downlink user data to the T-DU, so as to ensure that after the L1/L2 handover is completed, the T-DU can timely receive the downlink user data sent by the CU, thereby scheduling the UE in a new serving cell.

FIG. 5 is a schematic flowchart of an implementation of a handover method according to an embodiment of this application, where the method can be applied to a terminal. As shown in FIG. 5, a method 500 includes the following steps.

S502: The terminal monitors a Physical Downlink Control Channel (PDCCH) of a T-DU, to obtain a scheduling request sent by the T-DU.

S504: The terminal sends uplink data to the T-DU in a case that the terminal successfully receives, based on the scheduling request, a PDCCH including a Cell-Radio Network Temporary Identity (C-RNTI) allocated by a target cell.

According to the handover method provided in this embodiment of this application, the terminal monitors the PDCCH of the T-DU, to obtain the scheduling request sent by the T-DU. The terminal sends the uplink data to the T-DU in a case that the terminal successfully receives, based on the scheduling request, the PDCCH including the C-RNTI allocated by the target cell. This embodiment of this application helps the T-DU schedule the terminal to acknowledge completion or failure of handover, thereby avoiding failure of the L1/L2 handover of the terminal, and improving communication system performance.

In an embodiment, the uplink data includes at least one of the following: (1) HARQ Acknowledgement (ACK) or Negative Acknowledgement (NACK); (2) a CSI report; (3) a Radio Resource Control (RRC) reconfiguration completion message; or (4) an index or an identifier associated with an RRC reconfiguration message applied by the terminal.

In an embodiment, the method further includes: The terminal acknowledges failure of handover in a case that the terminal fails to receive, based on the scheduling request, a PDCCH including a C-RNTI allocated by a target cell within a length of a second timer.

To describe in detail the handover method provided in the embodiments of this application, the following provides description with reference to several specific embodiments.

### Embodiment 1

In this embodiment, an S-DU notifies a T-DU of initiation of handover, and this embodiment includes the following steps.

Step 1: The S-DU initiates L1/L2 handover or delivers an L1/L2 handover command to UE.

Step 2: For inter-DU L1/L2 handover, in some embodiments, the S-DU sends an interface message to a CU, for example, a UE Context Modification Require message. After receiving the interface message, the CU sends an interface message to the T-DU, for example, a UE Context Modification Request message. The foregoing interface message is associated with to-be-handed-over UE.

The foregoing interface message includes at least one of the following Information Elements (IEs):
(1) a handover initiation indication, or referred to as indication information used to indicate that L1/L2 handover has been initiated;
(2) identity information of a target cell, where the identity information includes, for example, a target cell Identity (ID), a Cell Global Identity (CGI), a Physical Cell Identifier (PCI), and the like;
(3) a TCI state associated with a PCI of a target cell;
(4) a quantity of times that the T-DU schedules the terminal, or referred to as a maximum quantity of times that the terminal is scheduled; or
(5) a length of a first timer, and the T-DU may schedule the terminal for multiple times within the length of the first timer.

No mandatory limitation is imposed on a sequence of occurrence of Step 1 and Step 2, that is, the sequence of Step 1 and Step 2 may be adjusted, or Step 1 and Step 2 may be initiated at the same time.

Step 3: The T-DU schedules the UE, where the scheduling may be at least one of the following behaviors:
(1) sending a UL Grant; or
(2) triggering aperiodic CSI reporting.

In this embodiment, if the first timer is configured, the T-DU starts the first timer after initiating scheduling for the UE.

In this embodiment, for inter-DU handover, the T-DU may perform Step 3 after receiving the interface message from the CU in Step 2.

Step 4: The T-DU acknowledges completion of handover in a case that the T-DU successfully decodes data carried in a PUCCH or a PUSCH that is sent by the UE. In some embodiments, the T-DU sends an interface message to the CU, for example, a UE Context Modification Response message, to indicate completion of L1/L2 handover to the CU.

In this embodiment, for inter-DU switching, after the CU receives the interface message, in some embodiments, the CU sends an interface message to the S-DU, for example, a UE Context Modification Confirm message, to indicate completion of L1/L2 handover to the S-DU.

The interface message may include at least one of the following:
(1) a UEID;
(2) an ID, a CGI or a PCI of a source cell;
(3) an ID, a CGI or a PCI of a target cell;
(4) an index or an identity associated with an applied RRC reconfiguration message; or
(5) an L1/L2 handover success indication.

Step 5: The T-DU schedules the UE again until a quantity of scheduling times exceeds a maximum quantity of scheduling times, or scheduling time exceeds a length of a first timer in a case that the T-DU fails to decode data carried in a PUCCH or PUSCH that is sent by the UE.

It may be understood that, in a case that the quantity of scheduling times does not exceed the maximum quantity of scheduling times or the scheduling time does not exceed the length of the first timer, if the T-DU successfully decodes the data carried in the PUCCH or the PUSCH that is sent by the UE, the T-DU may also stop scheduling the UE.

Step 6: In a case that the quantity of scheduling times of the UE by the T-DU exceeds the maximum quantity of scheduling times, or the scheduling time exceeds the length of the first timer, the T-DU stops scheduling the UE, and acknowledges failure of handover.

In some embodiments, the T-DU sends an interface message to the CU, for example, a UE Context Modification Require message, to indicate to the CU that the L1/L2 handover fails. For inter-DU handover, in some embodiments, the CU sends an interface message to the S-DU, for example, a UE Context Modification Confirm message, to indicate to the S-DU that the L1/L2 handover fails.

The interface message may include at least one of the following:
(1) a UEID;
(2) an ID, a CGI or a PCI of a source cell;
(3) an ID, a CGI or a PCI of a target cell;
(4) an index or an identity associated with an applied RRC reconfiguration message; or
(5) an L1/L2 handover failure indication.

The foregoing content in Embodiment 1 describes steps performed by a network side. For a terminal side, this embodiment includes the following steps.

Step 1: UE receives an L1/L2 handover command delivered by an S-DU, and uses saved synchronization reconfiguration of a target cell or saved synchronization reconfiguration of a target Secondary Cell Group (SCG).

Step 2: The UE monitors a PDCCH of a T-DU, decodes DCI to obtain a scheduling request sent by the T-DU, and the UE acknowledges completion of handover. The scheduling request includes at least one of the following:
(1) a UL grant; or
(2) aperiodic CSI reporting.

Step 3: The UE sends uplink data to the T-DU in a case that the UE successfully receives a PDCCH including a C-RNTI allocated by the target cell, where the uplink data is carried by using the PUCCH or the PUSCH, and the uplink data may be at least one of the following:
(1) HARQ ACK/NACK feedback;
(2) a CSI report;
(3) an RRC reconfiguration complete message; or
(4) an index or an identity associated with the RRC reconfiguration message applied by Step 1.

In this embodiment, the UE acknowledges failure of handover in a case that the UE fails to receive a PDCCH including a C-RNTI allocated by the target cell within a length of a second timer.

The length of the second timer is configured in the following manners:
(1) preconfigured by the RRC of the CU before the handover is initiated; and
(2) carried by the L1/L2 handover command delivered by the S-DU.

The second timer may be started after the UE receives the L1/L2 handover command delivered by the S-DU.

### Embodiment 2

In this embodiment, an S-DU sends an L1 measurement result of a candidate cell to a CU, and the CU modifies or releases the candidate cell based on the measurement result, or initiates L3 handover. This embodiment includes the following steps.

Step 1: The S-DU receives the L1 measurement result reported by UE.

Step 2: The S-DU sends an interface message to the CU, for example, a UE Context Modification Require message, where the message includes at least one of the following IEs:
(1) an ID of each candidate cell;
(2) an L1 measurement result of each candidate cell; or
(3) a UE ID;

A sending occasion of the seventh interface message may be one of the following:
(1) sent periodically, and a period may be configured by the CU;
(2) sent when the S-DU initiates the L1/L2 handover or delivers an L1/L2 handover command;
(3) sent when the S-DU receives a HARQ feedback for an L1/L2 handover command; or
(4) sent when the S-DU receives the L1 measurement result reported by the UE.

Step 3: The CU modifies and deletes the configuration of the candidate cell based on the L1 measurement result reported by the S-DU, or initiates the L3 handover.

### Embodiment 3

In this embodiment, an S-DU sends an L1 measurement result of a candidate cell and/or a CSI measurement result of the candidate cell to a T-DU, so that the T-DU performs scheduling in a timely manner after completion of handover. This embodiment includes the following steps.

Step 1: The S-DU receives the L1 measurement result and/or the CSI measurement result that is of the candidate cell and that is reported by UE.

Step 2: For inter-DU handover, in some embodiments, the S-DU sends an interface message to a CU, where the interface message includes at least one of the following IEs:
(1) an ID, a CGI or a PCI of the candidate cell;
(2) the L1 measurement result of the candidate cell, such as a Signal to Interference plus Noise Ratio (SINR), a Signal Noise Ratio (SNR), Reference Signal Receiving Power (RSRP), or Reference Signal Receiving Quality (RSRQ);
(3) the CSI measurement result of the candidate cell, such as a Rank Indication (RI), a Channel Quality Indicator (CQI), a CSI-RS Resource Indicator (CRI), a Layer Indicator (LI), a Pre-coding Matrix Indicator (PMI); or
(4) a UE ID.

In some embodiments, a sending occasion of the interface message may be:
(1) sent periodically, and a period may be configured by the CU;
(2) sent when the S-DU initiates the L1/L2 handover or delivers an L1/L2 handover command;
(3) sent when the S-DU receives a HARQ feedback for an L1/L2 handover command; or
(4) sent when the S-DU receives the L1 measurement result and/or the CSI measurement result reported by the UE.

In a case that the S-DU sends the foregoing interface message when initiating the L1/L2 handover or receiving the HARQ feedback for the L1/L2 handover, the S-DU may send only a CSI measurement result of a target cell, but does not include a CSI measurement result of another candidate cell.

Step 3: For inter-DU handover, in some embodiments, after receiving the interface message, the CU sends an interface message to the T-DU, where the interface message includes at least one of the following IEs:
(1) an ID, a CGI or a PCI of the candidate cell;
(2) the L1 measurement result of the candidate cell;
(3) the CSI measurement result of the candidate cell; or
(4) a UE ID.

Step 4: After the handover of the UE is completed, the T-DU makes a decision on scheduling based on the CSI measurement result, and the T-DU performs L1/L2 handover judgment based on the L1 measurement result of the candidate cell.

### Embodiment 4

In this embodiment, a T-DU sends a TA value that is of UE and that is in a candidate cell to an S-DU, thereby reducing a delay of uplink synchronization when the UE is handed over. This embodiment includes the following steps.

Step 0: For inter-DU handover, in some embodiments, the T-DU sends an interface message to a CU, where the interface message includes a RACH resource or an SRS resource that is allocated by the candidate cell to the UE; and the CU sends an interface message to the S-DU, where the message includes a RACH resource or an SRS resource that is allocated by the candidate cell to the UE.

The tenth interface message or the eleventh interface message includes at least one of the following IEs:
(1) a UEID.
(2) an ID, a CGI or a PCI of a source cell;
(3) an ID, a CGI or a PCI of the candidate cell; or
(4) a RACH resource or an SRS resource that is allocated by the candidate cell to the UE.

In some embodiments, for inter-DU handover, before Step 0, the S-DU sends an interface message to the CU, where the interface message includes a request to the candidate cell to allocate an RACH resource or an SRS resource to the UE; and the CU sends an interface message to the T-DU, where the interface message includes a request to the candidate cell to allocate an RACH resource or an SRS resource to the UE.

The interface message includes at least one of the following IEs:
(1) a UEID.
(2) an ID, a CGI or a PCI of a source cell;
(3) an ID, a CGI or a PCI of the candidate cell; or
(4) indication information used to request a RACH resource or an SRS resource.

Step 1: The S-DU sends, to the UE, the RACH resource or the SRS resource that is allocated by the candidate cell to the UE.

The RACH resource or the SRS resource that is allocated by the candidate cell includes at least one of the following:
(1) a frequency, a time-frequency domain position, a sending period, an offset, an uplink carrier used, or the like that is of the RACH resource or the SRS resource;
(2) an RS index (such as ssb-Index or csi-RS-Index) of a candidate cell associated with the RACH resource or the SRS resource;
(3) an ID or PCI of a candidate cell associated with the RACH resource or the SRS resource;
(4) a PRACH mask index; or
(5) one or more preamble indexes.

Step 1: The T-DU obtains the TA value that is of the UE and that is in the candidate cell based on the preamble or the SRS that is sent by the UE.

Step 2: For inter-DU handover, in some embodiments, the T-DU sends an interface message to a CU, for example, a UE Context Modification Require message, where the interface message carries at least one of the following IEs:
(1) an ID, a CGI or a PCI of a source cell;
(2) an ID, a CGI or a PCI of the candidate cell;
(3) the TA value of the candidate cell; or
(4) a UE ID.

Step 3: For inter-DU handover, in some embodiments, the CU sends an interface message to the S-DU, for example, a UE Context Modification Request message, where the message carries at least one of the following IEs:
(1) an ID, a CGI or a PCI of a source cell;
(2) an ID, a CGI or a PCI of the candidate cell;
(3) the TA value of the candidate cell; or
(4) a UE ID.

Step 4: The S-DU sends the TA value of the candidate cell to the UE, or carries a TA value of a target cell in an L1/L2 handover command when L1/L2 handover is triggered, where the L1/L2 handover command may be DCI or a MAC CE, and the TA value may be an absolute TA value that is of the UE and that is in the candidate cell, or may be a relative TA value relative to a TA value of a serving cell.

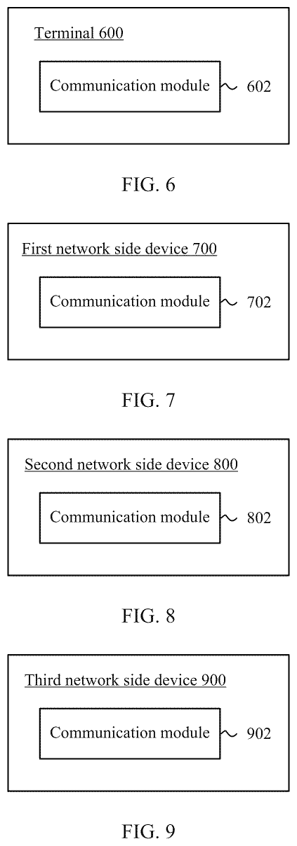

FIG. 6 is a schematic diagram of a structure of a terminal according to an embodiment of this application. As shown in FIG. 6, a terminal 600 includes the following module:

a communication module 602, configured to monitor a PDCCH of a T-DU, to obtain a scheduling request sent by the T-DU.

The communication module 602 is further configured to send uplink data to the T-DU in a case that a PDCCH including a C-RNTI allocated by a target cell is successfully received based on the scheduling request.

In some embodiments, the terminal 600 further includes a processing module.

In this embodiment of this application, the communication module monitors the PDCCH of the T-DU, to obtain the scheduling request sent by the T-DU; and sends the uplink data to the T-DU in a case that the PDCCH including the C-RNTI allocated by the target cell is successfully received based on the scheduling request. This embodiment of this application helps the T-DU schedule the terminal to acknowledge completion or failure of handover, thereby avoiding failure of the L1/L2 handover of the terminal, and improving communication system performance.

In an embodiment, the uplink data includes at least one of the following: (1) hybrid automatic repeat request acknowledgement HARQ ACK or negative acknowledgement NACK; (2) a CSI report; (3) an RRC reconfiguration completion message; or (4) an index or an identity associated with an RRC reconfiguration message applied by the terminal.

In an embodiment, the communication module 602 is further configured to acknowledge failure of handover in a case that the PDCCH including the C-RNTI allocated by the target cell is not successfully received based on the scheduling request within a length of a second timer.

The terminal 600 according to this embodiment of this application may correspond to the procedures of the method 500 in the embodiments of this application, and the units/modules in the terminal 600 and the foregoing operations and/or functions are respectively for implementing the corresponding procedures of the method 500, and a same or equivalent technical effect can be achieved. For brevity, details are not described herein again.

The terminal in this embodiment of this application may be an electronic device, for example, an electronic device with an operating system, or may be a component in the electronic device, for example, an integrated circuit or a chip. For example, the terminal may include but is not limited to the foregoing listed types of the terminal 11, and the another device may be a server, a Network Attached Storage (NAS), or the like. This is not limited in this embodiment of this application.

FIG. 7 is a schematic diagram of a structure of a first network side device according to an embodiment of this application. The first network side device may correspond to the S-DU in other embodiments. As shown in FIG. 7, a first network side device 700 includes the following module:

a communication module 702, configured to initiate L1/L2 handover.

The communication module 702 is further configured to perform at least one of the following: send a first interface message to a T-DU, or receive a second interface message, where the first interface message is used to indicate the T-DU to schedule a terminal; and the second interface message includes a timing advance TA value of a candidate cell, and the TA value of the candidate cell is used for uplink synchronization during handover of the terminal.

In some embodiments, the first network side device 700 further includes a processing module.

In some embodiments of this application, the first network side device initiates the L1/L2 handover and performs at least one of the following: sends the first interface message to the T-DU, or receives the second interface message. The first interface message is used to indicate the T-DU to schedule the terminal, to acknowledge completion or failure of handover, thereby avoiding failure of the L1/L2 handover of the terminal and improving communication system performance. The second interface message includes the TA value of the candidate cell, and the TA value of the candidate cell is used for uplink synchronization during handover of the terminal, thereby reducing a delay of the uplink synchronization during handover of the terminal, avoiding failure of the L1/L2 handover of the terminal, and improving communication system performance.

In an embodiment, the first interface message includes at least one of the following: (1) indication information used to indicate that L1/L2 handover has been initiated; (2) identity information of a target cell; (3) a transmission configuration indicator TCI state associated with a target cell; (4) a maximum quantity of times that the T-DU schedules the terminal; or (5) a length of a first timer, where the T-DU schedules the terminal during running of the first timer; and the target cell is a serving cell after the L1/L2 handover of the terminal.

In an embodiment, the communication module 702 is further configured to receive a third interface message, where the third interface message is sent from the T-DU after confirming the handover is completed or failed, and the third interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; (4) an index or an identity associated with an applied radio resource control RRC reconfiguration message; or (5) indication information used to indicate completion or failure of L1/L2 handover.

In an embodiment, the second interface message further includes at least one of the following: (1) identity information of a source cell, where the source cell is a serving cell before the L1/L2 handover of the terminal; (2) identity information of a candidate cell, where the candidate cell is a candidate cell for the L1/L2 handover of the terminal; or (3) identity information of the terminal.

In an embodiment, the communication module 702 is further configured to send, to the terminal, a RACH resource or an SRS resource, where the RACH resource or the SRS resource is allocated by a candidate cell to the terminal, and the RACH resource or the SRS resource is used to obtain the TA value of the candidate cell.

In an embodiment, the communication module 702 is further configured to receive a fourth interface message, where the fourth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) a RACH resource or an SRS resource allocated by a candidate cell to the terminal.

In an embodiment, the communication module 702 is further configured to send a fifth interface message, where the fifth interface message is used to request the RACH resource or the SRS resource, and the fifth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) indication information used to request an RACH resource or an SRS resource.

In an embodiment, the RACH resource includes at least one of the following: a frequency, a time-frequency domain position, a sending period, an offset, an uplink carrier used, an RS index of an associated candidate cell, identity information of an associated candidate cell, a PRACH mask index, or a preamble index. The SRS resource includes at least one of the following: a frequency, a time-frequency domain position, a sending period, an offset, an uplink carrier used by the terminal, an RS index of an associated candidate cell, or identity information of an associated candidate cell.

In an embodiment, the communication module 702 is further configured to send the TA value of the candidate cell to the terminal; or carry a TA value of a target cell in an L1/L2 handover command, where the target cell is a serving cell after the L1/L2 handover of the terminal.

In an embodiment, the communication module 702 is further configured to send a sixth interface message to the T-DU or the CU, where the sixth interface message includes at least one of the following: (1) identity information of a candidate cell; (2) an L1 measurement result of a candidate cell; (3) a CSI measurement result of a candidate cell; or (4) identity information of the terminal, where the candidate cell is a candidate cell for the L1/L2 handover of the terminal.

In an embodiment, a sending occasion of the sixth interface message is one of the following: (1) sent periodically; (2) sent when the L1/L2 handover is initiated or an L1/L2 handover command is delivered; (3) sent when a HARQ feedback for an L1/L2 handover command is received; (4) sent when an L1 measurement result reported by the terminal is received; or (5) sent when an CSI measurement result reported by the terminal is received.

In an embodiment, the sending occasion of the sixth interface message sending occasion is: sent when the L1/L2 handover is initiated; or sent when the HARQ feedback for the L1/L2 handover command is received, where the CSI measurement result of the candidate cell is a CSI measurement result of a target cell, and the target cell is a serving cell after the L1/L2 handover of the terminal.

The first network side device 700 according to this embodiment of this application may correspond to the procedures of the method 200 in the embodiments of this application, and the units/modules in the first network side device 700 and the foregoing operations and/or functions are respectively for implementing the corresponding procedures of the method 200, and a same or equivalent technical effect can be achieved. For brevity, details are not described herein again.

FIG. 8 is a schematic diagram of a structure of a second network side device according to an embodiment of this application. The second network side device may correspond to the T-DU in other embodiments. As shown in FIG. 8, a second network side device 800 includes the following module:

a communication module 802, configured to perform at least one of the following: receive a first interface message, or sends a second interface message to an S-DU, where the first interface message is used to indicate the second network side device to schedule a terminal; and the second interface message includes a TA value of a candidate cell, the TA value of the candidate cell is used by the S-DU for performing sending to the terminal, and the TA value of the candidate cell is used for uplink synchronization during handover of the terminal.

In some embodiments, the second network side device 800 further includes a processing module.

In some embodiments of this application, the second network side device performs at least one of the following: receives the first interface message, or sends the second interface message to the S-DU. The first interface message is used to indicate the second network side device to schedule the terminal, to acknowledge completion or failure of handover, thereby avoiding failure of the L1/L2 handover of the terminal and improving communication system performance. The second interface message includes the TA value of the candidate cell, and the TA value of the candidate cell is used for uplink synchronization during handover of the terminal, thereby reducing a delay of the uplink synchronization during handover of the terminal, avoiding failure of the L1/L2 handover of the terminal, and improving communication system performance.

In an embodiment, the first interface message includes at least one of the following: (1) indication information used to indicate that L1/L2 handover has been initiated; (2) identity information of a target cell; (3) a TCI state associated with a target cell; (4) a maximum quantity of times that the T-DU schedules the terminal; or (5) a length of a first timer, where the T-DU schedules the terminal during running of the first timer; and the target cell is a serving cell after the L1/L2 handover of the terminal.

In an embodiment, that the second network side device schedules the terminal includes at least one of the following: (1) sending an uplink grant to the terminal; and (2) triggering the terminal to perform aperiodic CSI reporting.

In an embodiment, the method further includes acknowledging completion of handover in a case that the T-DU successfully decodes data carried in an uplink channel sent by the terminal.

In an embodiment, the communication module 802 is further configured to schedule the terminal again until a quantity of scheduling times exceeds a maximum quantity of times of scheduling the terminal, or scheduling time exceeds a length of a first timer in a case that data carried in an uplink channel sent by the terminal is not successfully decoded.

In an embodiment, the communication module 802 is further configured to: stop scheduling the terminal, and acknowledge failure of handover in a case that the quantity of scheduling times of the terminal reaches or exceeds the maximum quantity of times of scheduling the terminal, or the scheduling time exceeds the length of the first timer.

In an embodiment, the communication module 802 is further configured to send a third interface message, where the third interface message is sent from the second network side device after confirming the handover is completed or failed, and the third interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; (4) an index or an identity associated with an applied RRC reconfiguration message; or (5) indication information used to indicate completion or failure of L1/L2 handover.

In an embodiment, the second interface message further includes at least one of the following: (1) identity information of a source cell, where the source cell is a serving cell before the L1/L2 handover of the terminal; (2) identity information of a candidate cell, where the candidate cell is a candidate cell for the L1/L2 handover of the terminal; or (3) identity information of the terminal.

In an embodiment, the communication module 802 is further configured to obtain the TA value of the candidate cell based on a preamble or an SRS that is sent by the terminal.

In an embodiment, the communication module 802 is further configured to send a fourth interface message, where the fourth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) a RACH resource or an SRS resource allocated by a candidate cell to the terminal.

In an embodiment, the communication module 802 is further configured to receive a fifth interface message, where the fifth interface message is used to request the RACH resource or the SRS resource, and the fifth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) indication information used to request an RACH resource or an SRS resource.

In an embodiment, the RACH resource includes at least one of the following: a frequency, a time-frequency domain position, a sending period, an offset, an uplink carrier used, an RS index of an associated candidate cell, identity information of an associated candidate cell, a PRACH mask index, or a preamble index. The SRS resource includes at least one of the following: a frequency, a time-frequency domain position, a sending period, an offset, an uplink carrier used by the terminal, an RS index of an associated candidate cell, or identity information of an associated candidate cell.

In an embodiment, the communication module 802 is further configured to receive a sixth interface message, where the sixth interface message includes at least one of the following: (1) identity information of a candidate cell; (2) an L1 measurement result of a candidate cell; (3) a CSI measurement result of a candidate cell; or (4) identity information of the terminal, where the candidate cell is a candidate cell for the L1/L2 handover of the terminal.

The second network side device 800 according to this embodiment of this application may correspond to the procedures of the method 300 in the embodiments of this application, and the units/modules in the second network side device 800 and the foregoing operations and/or functions are respectively for implementing the corresponding procedures of the method 300, and a same or equivalent technical effect can be achieved. For brevity, details are not described herein again.

FIG. 9 is a schematic diagram of a structure of a third network side device according to an embodiment of this application. The third network side device may correspond to the CU in other embodiments. As shown in FIG. 9, a third network side device 900 includes the following module:

a communication module 902, configured to perform at least one of the following: send a first interface message to a T-DU, send a second interface message to an S-DU, receive a first interface message sent by an S-DU, or receive a third interface message sent by a T-DU, where the first interface message is used to indicate the T-DU to schedule a terminal; and the second interface message includes a TA value of a candidate cell, and the TA value of the candidate cell is used for uplink synchronization during handover of the terminal.

In some embodiments, the third network side device 900 further includes a processing module.

In this embodiment of this application, the third network side device performs at least one of the following: sends the first interface message to the T-DU, or sends the second interface message to the S-DU. The first interface message is used to indicate the T-DU to schedule the terminal, to acknowledge completion or failure of handover, thereby avoiding failure of the L1/L2 handover of the terminal and improving communication system performance. The second interface message includes the TA value of the candidate cell, and the TA value of the candidate cell is used for uplink synchronization during handover of the terminal, thereby reducing a delay of the uplink synchronization during handover of the terminal, avoiding failure of the L1/L2 handover of the terminal, and improving communication system performance.

In an embodiment, the first interface message includes at least one of the following: (1) indication information used to indicate that L1/L2 handover has been initiated; (2) identity information of a target cell; (3) a transmission configuration indicator TCI state associated with a target cell; (4) a maximum quantity of times that the T-DU schedules the terminal; or (5) a length of a first timer, where the T-DU schedules the terminal during running of the first timer; and the target cell is a serving cell after the L1/L2 handover of the terminal.

In an embodiment, the communication module 902 is further configured to send a third interface message to the S-DU, where the third interface message is sent from the T-DU after confirming the handover is completed or failed, and the third interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; (4) an index or an identity associated with an applied RRC reconfiguration message; or (5) indication information used to indicate completion or failure of L1/L2 handover.

In an embodiment, the second interface message further includes at least one of the following: (1) identity information of a source cell, where the source cell is a serving cell before the L1/L2 handover of the terminal; (2) identity information of a candidate cell, where the candidate cell is a candidate cell for the L1/L2 handover of the terminal; or (3) identity information of the terminal.

In an embodiment, the communication module 902 is further configured to send a fourth interface message to the S-DU, where the fourth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) a RACH resource or an SRS resource allocated by a candidate cell to the terminal.

In an embodiment, the communication module 902 is further configured to send a fifth interface message to the T-DU, where the fifth interface message is used to request the RACH resource or the SRS resource, and the fifth interface message includes at least one of the following: (1) identity information of the terminal; (2) identity information of a source cell, where the source cell is a serving cell before the L1/L2 handover of the terminal; (3) identity information of a target cell, where the target cell is a serving cell after the L1/L2 handover of the terminal; or (4) indication information used to request an RACH resource or an SRS resource.

In an embodiment, the communication module 902 is further configured to receive a sixth interface message from the S-DU, where the sixth interface message includes at least one of the following: (1) identity information of a candidate cell; (2) an L1 measurement result of a candidate cell; (3) a channel state information CSI measurement result of a candidate cell; or (4) identity information of the terminal, where the candidate cell is a candidate cell for the L1/L2 handover of the terminal.

The third network side device 900 according to this embodiment of this application may correspond to the procedures of the method 400 in the embodiments of this application, and the units/modules in the third network side device 900 and the foregoing operations and/or functions are respectively for implementing the corresponding procedures of the method 400, and a same or equivalent technical effect can be achieved. For brevity, details are not described herein again.

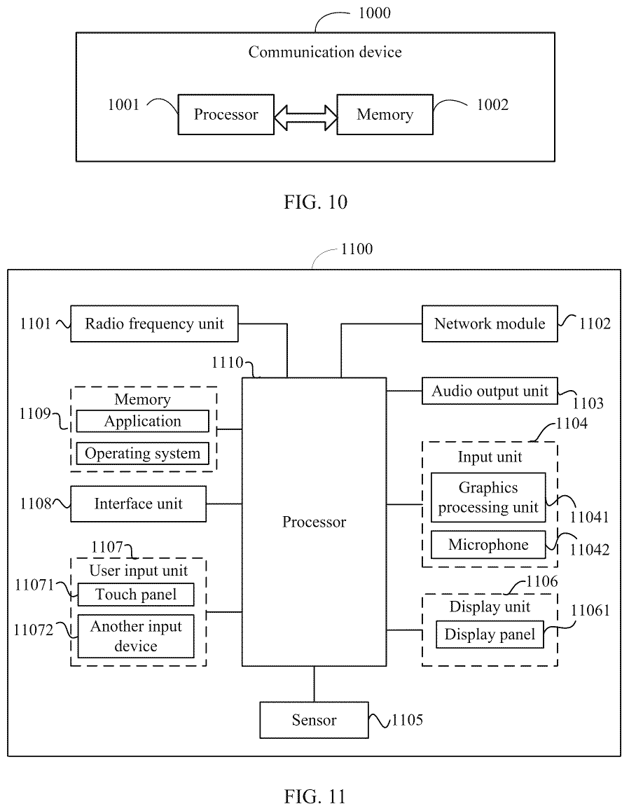

As shown in FIG. 10, an embodiment of this application further provides a communication device 1000, including a processor 1001 and a memory 1002, and the memory 1002 stores a program or an instruction that can be run on the processor 1001. For example, in a case that the communication device 1000 is a terminal, the program or the instruction is executed by the processor 1001 to implement the steps of the foregoing handover method embodiment, and a same technical effect can be achieved. When the communication device 1000 is a network side device, the program or the instruction is executed by the processor 1001 to implement the steps of the foregoing handover method embodiment, and a same technical effect can be achieved. To avoid repetition, details are not described herein again.

An embodiment of this application further provides a terminal including a processor and a communication interface, where the communication interface is configured to: monitor a PDCCH of a T-DU, to obtain a scheduling request sent by the T-DU; and send uplink data to the T-DU in a case that a PDCCH including a C-RNTI allocated by a target cell is successfully received based on the scheduling request. The terminal embodiment is corresponding to the method embodiment on the terminal side, each implementation process and implementation of the method embodiment can be applied to the terminal embodiment, and a same technical effect can be achieved. FIG. 11 is a schematic diagram of a hardware structure of a terminal according to an embodiment of this application.

The terminal 1100 includes but is not limited to at least a part of components such as a radio frequency unit 1101, a network module 1102, an audio output unit 1103, an input unit 1104, a sensor 1105, a display unit 1106, a user input unit 1107, an interface unit 1108, a memory 1109, and a processor 1110.

A person skilled in the art can understand that the terminal 1100 may further include a power supply (such as a battery) that supplies power to each component. The power supply may be logically connected to the processor 1110 by using a power supply management system, to implement functions such as charging and discharging management, and power consumption management by using the power supply management system. The terminal structure shown in FIG. 11 constitutes no limitation on the terminal, and the terminal may include more or fewer components than those shown in the figure, or combine some components, or have different component arrangements. Details are not described herein.

It should be understood that in this embodiment of this application, the input unit 1104 may include a Graphics Processing Unit (GPU) 11041 and a microphone 11042. The graphics processing unit 11041 processes image data of a static picture or a video obtained by an image capture apparatus (for example, a camera) in a video capture mode or an image capture mode. The display unit 1106 may include a display panel 11061, and the display panel 11061 may be configured in a form of a liquid crystal display, an organic light-emitting diode, or the like. The user input unit 1107 includes at least one of a touch panel 11071 and another input device 11072. The touch panel 11071 is also referred to as a touchscreen. The touch panel 11071 may include two parts: a touch detection apparatus and a touch controller. The another input device 11072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1101 may transmit the downlink data to the processor 1110 for processing. In addition, the radio frequency unit 1101 may send uplink data to the network side device. Generally, the radio frequency unit 1101 includes but is not limited to an antenna, an amplifier, a transceiver, a coupler, a low noise amplifier, a duplexer, and the like.

The memory 1109 may be configured to store a software program or an instruction and various data. The memory 1109 may mainly include a first storage area for storing a program or an instruction and a second storage area for storing data. The first storage area may store an operating system, and an application or an instruction required by at least one function (for example, a sound playing function or an image playing function). In addition, the memory 1109 may be a volatile memory or a non-volatile memory, or the memory 1109 may include a volatile memory and a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch link DRAM (SLDRAM), and a Direct Rambus RAM (DRRAM). The memory 1109 in this embodiment of this application includes but is not limited to these memories and any memory of another proper type.

The processor 1110 may include one or more processing units. In some embodiments, an application processor and a modem processor are integrated into the processor 1110. The application processor mainly processes an operating system, a user interface, an application, or the like. The modem processor mainly processes a wireless communication signal, for example, a baseband processor. It may be understood that, the modem processor may not be integrated into the processor 1110.

The radio frequency unit 1101 may be configured to: monitor a PDCCH of a T-DU, to obtain a scheduling request sent by the T-DU; and send uplink data to the T-DU in a case that a PDCCH including a C-RNTI allocated by a target cell is successfully received based on the scheduling request.

In this embodiment of this application, the terminal monitors the PDCCH of the T-DU, to obtain the scheduling request sent by the T-DU; and sends the uplink data to the T-DU in a case that the PDCCH including the C-RNTI allocated by the target cell is successfully received based on the scheduling request. This embodiment of this application helps the T-DU schedule the terminal to acknowledge completion or failure of handover, thereby avoiding failure of the L1/L2 handover of the terminal, and improving communication system performance.

The terminal 1100 provided in this embodiment of this application may further implement the processes of the foregoing handover method embodiment, and a same technical effect can be achieved. To avoid repetition, details are not described herein again.

An embodiment of this application further provides a network side device, including a processor and a communication interface, and the communication interface may be configured to perform the methods according to any one of FIG. 2 to FIG. 4. This network side device embodiment is corresponding to the foregoing method embodiment of the network side device. Each implementation process and implementation of the foregoing method embodiment may be applicable to this network side device embodiment, and a same technical effect can be achieved.

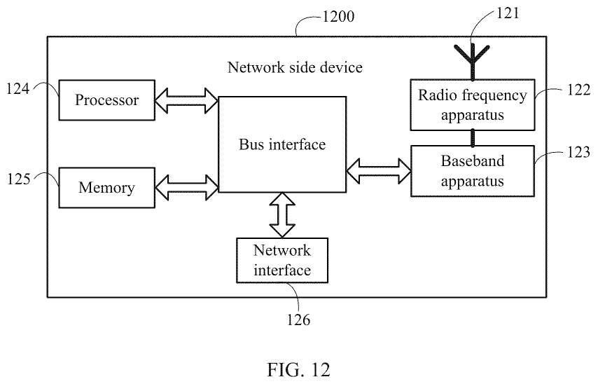

An embodiment of this application further provides a network side device. As shown in FIG. 12, the network side device 1200 includes an antenna 121, a radio frequency apparatus 122, a baseband apparatus 123, a processor 124, and a memory 125. The antenna 121 is connected to the radio frequency apparatus 122. In an uplink direction, the radio frequency apparatus 122 receives information through the antenna 121, and sends the received information to the baseband apparatus 123 for processing. In a downlink direction, the baseband apparatus 123 processes information that needs to be sent, and sends processed information to the radio frequency apparatus 122. The radio frequency apparatus 122 processes the received information, and sends processed information through the antenna 121.

In the foregoing embodiment, the method performed by the network side device may be implemented in the baseband apparatus 123. The baseband apparatus 123 includes a baseband processor.

For example, the baseband apparatus 123 may include at least one baseband board. A plurality of chips are disposed on the baseband board. As shown in FIG. 12, one chip is, for example, a baseband processor, and is connected to the memory 125 by using a bus interface, to invoke a program in the memory 125 to perform the operations of the network device shown in the foregoing method embodiment.

The network side device may further include a network interface 126, and the interface is, for example, a common public radio interface (CPRI).

The network side device 1200 in some embodiments of this application further includes an instruction or a program that is stored in the memory 125 and that can be run on the processor 124. The processor 124 invokes the instruction or the program in the memory 125 to perform the method performed by the modules shown in any one of FIG. 7 to FIG. 9, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing handover method embodiment, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing handover method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the computer program/program product is executed by at least one processor to implement the processes of the foregoing handover method embodiment, and a same technical effect can be achieved. To avoid repetition, details are not described herein again.

An embodiment of this application further provides an L1/L2 handover system, including a terminal and a network side device. The terminal may be configured to perform the steps of the foregoing handover method, and the network side device may be configured to perform the steps of the foregoing handover method.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. A handover method, comprising:
initiating, by a source-distributed unit (S-DU), layer 1 (L1)/layer 2 (L2) handover;
sending, by the S-DU, a first interface message to a centralized unit (CU); wherein the first interface message is sent from the CU to a target-distributed unit (T-DU) after receiving the first interface message, wherein the first interface message comprises at least one of the following:
indication information used to indicate that L1/L2 handover has been initiated;
identity information of a target cell;
a transmission configuration indicator (TCI) state associated with a target cell;
a maximum quantity of times that the T-DU schedules a terminal; or
a length of a first timer, wherein the T-DU schedules the terminal during running of the first timer, or
receiving a second interface message by the S-DU, wherein the second interface message comprises a timing advance (TA) value of a candidate cell, and the TA value of the candidate cell is used for uplink synchronization during handover of the terminal.

2. The handover method according to claim 1, wherein initiating, by the source-distributed unit (S-DU), the L1/L2 handover comprises:
the S-DU sending a L1/L2 handover command to the terminal.

3. The handover method according to claim 1, wherein after sending, by the S-DU, the first interface message to the CU, the handover method further comprises:
receiving, by the S-DU, a third interface message, wherein the third interface message is configured to indicate that the handover is completed or failed, and the third interface message comprises at least one of the following:
identity information of the terminal;
identity information of a source cell;
identity information of a target cell;
an index or an identifier associated with an applied radio resource control (RRC) reconfiguration message; or
indication information used to indicate completion or failure of L1/L2 handover.

4. The handover method according to claim 1, wherein before the receiving, by the S-DU, the second interface message, the handover method further comprises:
sending, by the S-DU to the terminal, a random access channel (RACH) resource or a sounding reference signal (SRS) resource, wherein the RACH resource or the SRS resource is allocated by a candidate cell to the terminal,
wherein the RACH resource or the SRS resource is used to obtain the TA value of the candidate cell.

5. The handover method according to claim 4, wherein before sending, by the S-DU, the RACH resource or the SRS resource to the terminal, the handover method further comprises:
receiving, by the S-DU, a fourth interface message, wherein the fourth interface message comprises at least one of the following:
identity information of the terminal;
identity information of a source cell;
identity information of a target cell; or
a RACH resource or an SRS resource allocated by a candidate cell to the terminal.

6. The handover method according to claim 5, wherein before the receiving, by the S-DU, the fourth interface message, the handover method further comprises: sending, by the S-DU, a fifth interface message, wherein the fifth interface message is used to request the RACH resource or the SRS resource, and the fifth interface message comprises at least one of the following:
identity information of the terminal;
identity information of a source cell;
identity information of a target cell; or
indication information used to request a RACH resource or an SRS resource.

7. The handover method according to claim 4, wherein:
the RACH resource comprises at least one of the following: a frequency, a time-frequency domain position, a sending period, an offset, an uplink carrier used, a reference signal (RS) index of an associated candidate cell, identity information of an associated candidate cell, a physical random access channel (PRACH) mask index, or a random access preamble index; and
the SRS resource comprises at least one of the following: a frequency, a time-frequency domain position, a sending period, an offset, an uplink carrier used by the terminal, an RS index of an associated candidate cell, or identity information of an associated candidate cell.

8. The handover method according to claim 1, wherein after receiving, by the S-DU, the second interface message, the handover method further comprises:
sending, by the S-DU, the TA value of the candidate cell to the terminal; or
the S-DU carries a TA value of a target cell in an L1/L2 handover command.

9. The handover method according to claim 1, wherein after initiating, by the source-distributed unit S-DU, the L1/L2 handover, the handover method further comprises:
sending, by the S-DU, a downlink data delivery status indication to the CU.

10. A handover method, comprising:
receiving, by a target-distributed unit (T-DU), a first interface message, wherein the first interface message comprises at least one of the following:
indication information used to indicate that L1/L2 handover has been initiated;
identity information of a target cell;
a transmission configuration indicator (TCI) state associated with a target cell;
a maximum quantity of times that the T-DU schedules a terminal; or
a length of a first timer, wherein the T-DU schedules the terminal during running of the first timer, or
sending, by the T-DU, an interface message comprising a timing advance (TA) value of a candidate cell to a centralized unit (CU), wherein a second interface message is sent from the CU to a source-distributed unit (S-DU),
wherein the second interface message comprises the TA value of the candidate cell, the TA value of the candidate cell is used by the S-DU for performing sending to the terminal, and the TA value of the candidate cell is used for uplink synchronization during handover of the terminal.

11. The handover method according to claim 10, wherein receiving, by the T-DU, the first interface message comprises:
receiving, by the T-DU, the first interface message from the CU.

12. The handover method according to claim 10, wherein after receiving, by the T-DU, the first interface message, the handover method further comprises:
sending, by the T-DU, a third interface message, wherein the third interface message is sent from the T-DU after confirming the handover is completed or failed, and the third interface message comprises at least one of the following:
identity information of the terminal;
identity information of a source cell;
identity information of a target cell;
an index or an identifier associated with an applied radio resource control (RRC) reconfiguration message; or
indication information used to indicate completion or failure of L1/L2 handover.

13. The handover method according to claim 10, wherein before sending, by the T-DU, the interface message comprising the TA value of the candidate cell to the CU, the handover method further comprises:
obtaining, by the T-DU, the TA value of the candidate cell based on a preamble or an SRS that is sent by the terminal.

14. The handover method according to claim 13, wherein before obtaining, by the T-DU, the TA value of the candidate cell based on the preamble or the SRS that is sent by the terminal, the handover method further comprises:
sending, by the T-DU, a fourth interface message, wherein the fourth interface message comprises at least one of the following:
identity information of the terminal;
identity information of a source cell;
identity information of a target cell; or
a RACH resource or an SRS resource allocated by a candidate cell to the terminal.

15. The handover method according to claim 14, wherein before sending, by the T-DU, the fourth interface message, the handover method further comprises:
receiving, by the T-DU, a fifth interface message, wherein the fifth interface message is used to request the RACH resource or the SRS resource, and the fifth interface message comprises at least one of the following:
identity information of the terminal;
identity information of a source cell;
identity information of a target cell; or
indication information used to request a RACH resource or an SRS resource.

16. A handover method, comprising:
receiving, by a centralized unit (CU), a first interface message from a source-distributed unit (S-DU), and sending, by the CU, the first interface message to a target-distributed unit (T-DU), wherein the first interface message comprises at least one of the following:
indication information used to indicate that L1/L2 handover has been initiated;
identity information of a target cell;
a transmission configuration indicator (TCI) state associated with a target cell;
a maximum quantity of times that the T-DU schedules a terminal; or
a length of a first timer, wherein the T-DU schedules the terminal during running of the first timer, or
sending, by the CU, a second interface message to the S-DU, wherein the second interface message comprises a timing advance (TA) value of a candidate cell, and the TA value of the candidate cell is used for uplink synchronization during handover of the terminal.

17. The handover method according to claim 16, wherein after sending, by the CU, the first interface message to the T-DU, the handover method further comprises:
receiving, by the CU, a third interface message from the T-DU; and
sending, by the CU, the third interface message to the S-DU, wherein the third interface message is configured to indicate that the handover is completed or failed, and the third interface message comprises at least one of the following:
identity information of the terminal;
identity information of a source cell;
identity information of a target cell;
an index or an identifier associated with an applied radio resource control (RRC) reconfiguration message; or
indication information used to indicate completion or failure of L1/L2 handover.

18. The handover method according to claim 16, wherein before sending, by the CU, the second interface message to the S-DU, the handover method further comprises: sending, by the CU, a fourth interface message to the S-DU, wherein the fourth interface message comprises at least one of the following:
identity information of the terminal;
identity information of a source cell;
identity information of a target cell; or
a RACH resource or an SRS resource allocated by a candidate cell to the terminal.

19. The handover method according to claim 18, further comprising: sending, by the CU, a fifth interface message to the T-DU, wherein the fifth interface message is used to request the RACH resource or the SRS resource, and the fifth interface message comprises at least one of the following:
identity information of the terminal;
identity information of a source cell;
identity information of a target cell; or
indication information used to request a RACH resource or an SRS resource.

20. The handover method according to claim 16, further comprising:
receiving, by the CU, a downlink data delivery status indication that is sent by the S-DU; and
after receiving the first interface message and the downlink data delivery status indication, starting, by the CU, to send downlink user data to the T-DU.

21. A handover method, comprising:
receiving, by a terminal, layer 1 (L1)/layer 2 (L2) handover command from a source-distributed unit (S-DU);
after the terminal receiving the L1/L2 handover command, monitoring, by the terminal, a physical downlink control channel (PDCCH) of a target-distributed unit (T-DU), to obtain a scheduling request sent by the T-DU; and
sending, by the terminal, uplink data to the T-DU when the terminal successfully receives, based on the scheduling request, a PDCCH comprising a cell-radio network temporary identity (C-RNTI) allocated by a target cell.
